(19) United States
(12) Patent Application Publication
(10) Pub. No.: US 2008/0162654 A1
(43) Pub. Date: Jul. 3, 2008

(54) Anonymous network communication system and methods of doing business

(76) Inventors: Heather C. Corfee, Sacramento, CA (US); Kea Charmak, Carmichael, CA (US)

Correspondence Address: HOLLAND & HART, LLP, P.O BOX 8749, DENVER, CO, 80201, US

(21) Appl. No.: 11/906,069

(22) Filed: Sep. 28, 2007

Related U.S. Application Data
(60) Provisional application No. 60/847,733, filed on Sep. 28, 2006.

(51) Int. Cl. G06F 15/16; G06Q 99/00

(52) U.S. Cl. 709/206; 705/1

(57) ABSTRACT

A communication system is provided to enable users to anonymously communicate, through various media, with others. In one aspect, a communications hub receives a communications directive from a user. The hub then acts on the directive, which may involve sending an electronic message, such as an email, to an intended recipient while maintaining the user's identity in confidence. The anonymous communication may take the form of a postal delivery and may include one or more products purchased by the user. The hub may serve as a host for a blog or other similar forum for the exchange of anonymous communications.

### CROSS-REFERENCE TO RELATED APPLICATION

The invention claims priority from U.S. Provisional Patent Application No. 60/847,733 entitled ANONYMOUS NETWORK COMMUNICATION SYSTEM AND METHODS OF DOING BUSINESS by Heather C. Corfee and Kea Charmak, filed on Sep. 28, 2006, which Provisional Patent Application is hereby incorporated by reference in its entirety.

### REFERENCE TO A COMPUTER PROGRAM LISTING APPENDIX

An original compact disk, and an identical, replacement copy thereof, containing the source code of a computer program that may be used with the present system is being filed with this application. The contents of the compact disks are incorporated into this application by reference. Per 37 CFR 1.52(e)(5), the files contained on the compact disks, along with its date of creation and file size (in bytes), are listed in the attached Appendix.

The files contained on the compact disks include the source code files in compliance with ASCII format. The files are provided on one (1) original compact disk, and an identical copy thereof, that is IBM-PC and MS-Windows compatible.

### BACKGROUND

Through the Internet, people have long engaged in blogging or live chats and discussion boards. Entities providing communication vehicles such as message boards or live chats also have provided other features such as product advertising and e-mailing facilities through or in connection with such boards or chat rooms. Certain Internet sites have also provided some anonymous communications vehicles, such as anonymous posting of messages and anonymous e-mail facilities.

The prior art has, however, failed to provide an anonymous network communications system that is versatile enough to use multimedia communications, let alone a system that incorporates methods of doing business. To applicant's knowledge no prior art communications networks have contemplated anonymous product purchasing and delivery to third parties as a form of “communicating.” Accordingly, such a communications system can serve as a base from which novel communities may grow and develop.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The present invention relates to providing novel anonymous networking and communications systems, methods of using the same, and the incorporation of such systems into methods of doing business. In a basic but preferred embodiment, a communications hub is provided for receiving and distributing communications to parties over one or more communications media. The hub receives communication directives from users that include instructions for the content and manner in which a communication is to be delivered to the one or more recipients. The hub delivers the communication to the recipient, via a first communications medium. The communication includes a presentation of a communicator identity to the recipient. However, the communicator identity relatives to the communication hub but not to the user who sent the communication.

In one embodiment, the system provides a web site available on a network such as the Internet, and the web site can provide one or more features providing and/or supporting various anonymous communications vehicles. The network may also be an intranet or other network available to a group of users. In one particular embodiment, an Internet website, as an example, may provide novel aspects and features, including: 1) e-commerce; 2) anonymous profiles; 3) social networking; 4) e-mail; 5) discussion board(s); 6) blogs; and 7) chat room(s).

In some embodiments, a user logging onto the site may anonymously inform a third party about the user's opinion or views of the third party or some aspect of the third party's activities, interests, associates, etc. The information conveyed to the third party may be positive, negative, neutral, humorous, informative in some other manner, etc.

In some embodiments, the user may use the system to provide the information through a variety of communication vehicles, including not only via anonymous network e-mail or postings, for example to a discussion board, blog, or chat room, but also through anonymous delivery of messages, products, or services. The messages, products, or services may be delivered to the third party that is the target of a message or in some other fashion that may be desired in order to communicate information anonymously.

As another example, in some embodiments the network site may provide access to products or services, such as pre-determined greeting cards, postcards, or other products or gifts or services offered through or in connection with the network system. When ordered by the user, such products or services might be sent anonymously to a third party by or for an operator of the site. The products or services may be ordered for delivery in the present or future. The order may also be recurring.

The system may also provide predetermined messages or other communications that the user may acquire through the network system for anonymous delivery to a third party. The network operator can then, if desired by the user, arrange for anonymous delivery of the communication, such as by e-mail, chat room, blog, conventional mail, or other communication vehicle.

The operator of the site may charge a fee for one or more of the activities, products, or services provided or supported by the system. The operator of the site may also charge a fee for advertising through the system or to users of the system or for providing information about use of the system or users of the system.

In certain embodiments, the network system can allow one or more users accessing the system to feel empowered by use of a computer as a mask; sending an anonymous email, gift, or greeting, or other product or service to or for someone they like or dislike—perhaps with the underlying goal of informing a third party how the user really feels without a risk or penalty that face-to-face communication may support.

In some embodiments, such a communication may be provided by or for the system or operator in connection with the applicant's proprietary trademark, “Smack.” In one such an embodiment, the user thus can visit the network system and provide a Smack™ communication to a third party.

Similarly, the third party might then similarly visit the system and procure a “Smack Back™” communication directed to the user who procured the original Smack™ communication. Such a return Smack™ communication might be referred to as a “Smack Dab™” communication when provided by or for the system or operator. The network system thus can provide a site that promotes perpetuation of its use by users and others who may learn of Smack™ communications, Smack™ Dab communications, etc.

In certain embodiments, the network system can also allow one or more users to each establish and manage the user's anonymous profile or personal web page. The user may be given a “Smacker™ ID” in order to do so, and this Smacker™ ID, identifying the user on the user's profile or web page, may provide the user with the desired anonymity. In certain embodiments, the user may post user secrets, dreams, desires, Smack™ activities; and in this fashion the network system can allow users to reveal such information with no, or reduced, risk of being identified, judged, or ridiculed.

In some embodiments, the network system or site may offer on- or off-line chatting, blogging, or one or more discussion boards for one or more users. In some embodiments, through the network system, one or more users may thus provide to one or more others information about Smack™ activities performed (such as, for example, jokes or their Smack™ activities, or may not want to, relay to someone else). In some embodiments, the network system can offer one or more contests for best or worst Smack™ activities, news about Smack™ activities or their impact, cartoons regarding Smack™ activities, access to system partners or advertisers (for example through links or other contact vehicles), a “contact us” communication vehicle, user registration, terms of use of the system, policing of Smack™ activity, etc. Fees may or may not be charged by the system provider for one or more such activities or features or portions of such activities or features.

In some embodiments, other examples of how the system might be utilized may include one of the following:

People commonly work with or for someone that they do not like or in circumstances that are unpleasant. People commonly leave an employment position but without a meaningful or sufficient opportunity to tell their boss or co-worker how they truly felt about the boss's or co-worker's management or work style, for example. People also commonly have involvement with others that have positively touched their lives but without any opportunity to communicate their appreciation. People also commonly develop secret “crushes” on others; wishing they could communicate their affection anonymously at least. Some embodiments of the present network system can provide an effective means of providing an anonymous communication outlet in one or more such circumstances, and do so in a manner that provides more robust features for the user.

A user also might use the system to inform a third party about a difficult or “sticky situation” that the user or others of interest may not feel comfortable about informing the third party in person, such as a spouse having an affair with another person in an office in which the spouse and other person might work.

In certain embodiments, the network system may be built on the premise that many people would like to feel empowered and express themselves realistically and with passion when leaving a work situation or even a bad relationship, marriage or friendship. Such a system may come into the lives of any individual needing and wanting to express their like, distaste, or dissatisfaction to someone, such as to or about persons or situations identified above. Through such a network system, the user may order and send an anonymous e-card, gift, or other product or service; and the nature of the message or information thus provided can be particularly effective by reason of having been predetermined and offered by or for the network system or operator. Similarly, the system can, if desired, provide an advertising and marketing vehicle for product or service suppliers to provide their products or services, which can include those that might be particularly needed or desired by users of such a system.

In some embodiments, the network system can be launched in phases. A first stage can be directed to, for example, employees working in companies. A second phase can be directed to, for example, past lovers/husbands/wives. A third stage can, for example, encourage others to communicate with old friends, girlfriends, neighbors, etc. Yet another stage can, for example, encourage users to communicate a secret to someone they know without revealing the users' identities.

In certain embodiments, the system and its features may be provided 24 hours a say, 7 days a week, 365 days per year, or otherwise as desired.

These and other aspects of various embodiments of the present invention will be apparent after consideration of the Detailed Description and Figures herein.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a functional block diagram of a computing system adapted to implement an embodiment of the present invention; and

FIG. 2 depicts a system schematic of one contemplated embodiment of the system of the present invention;

FIG. 3 depicts an exemplary screen shot of a login page and user interface from which a user may access the system and a personal account;

FIG. 4 depicts an exemplary screen shot of a home page and user interface from which the communication system may be accessed;

FIG. 5 depicts an exemplary screen shot of a user interface for entering and/or altering user account information within the communication system;

FIG. 6 depicts an exemplary screen shot of a user interface for preparing and transmitting an anonymous communication electronically;

FIG. 7 depicts an exemplary screen shot of a user interface for preparing and transmitting an anonymous communication through postal mail;

FIG. 8 depicts an exemplary screen shot of a user interface for preparing and transmitting an anonymous communication through a blog post;

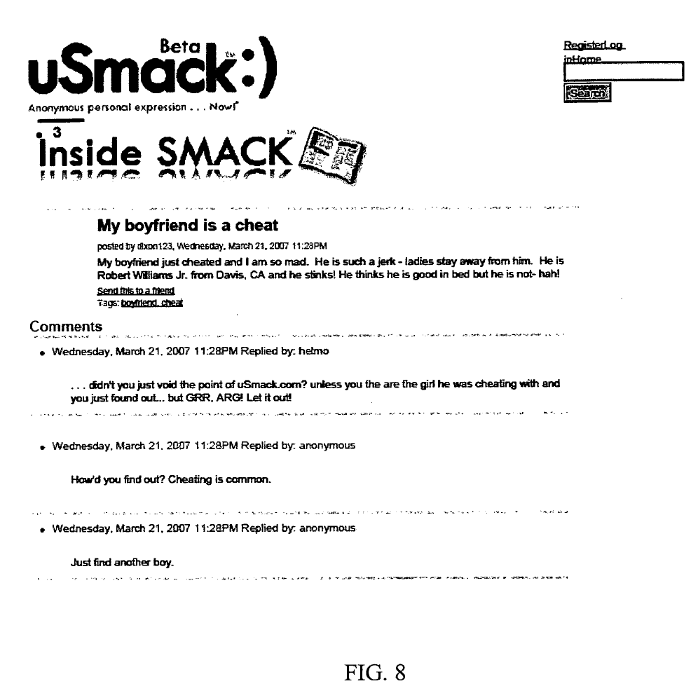

FIG. 9 depicts an exemplary screen shot of a user interface for searching a database for previously prepared communications;

FIG. 10 depicts an exemplary embodiment of a prepared postcard that may be purchased and completed by a user of the communication system;

FIG. 11 depicts an exemplary screen shot of a user interface for checking out and paying for one or more services and/or products;

FIG. 12a depicts a block diagram of an exemplary embodiment of a home page of the communication system and alternate pages that a user may select therefrom;

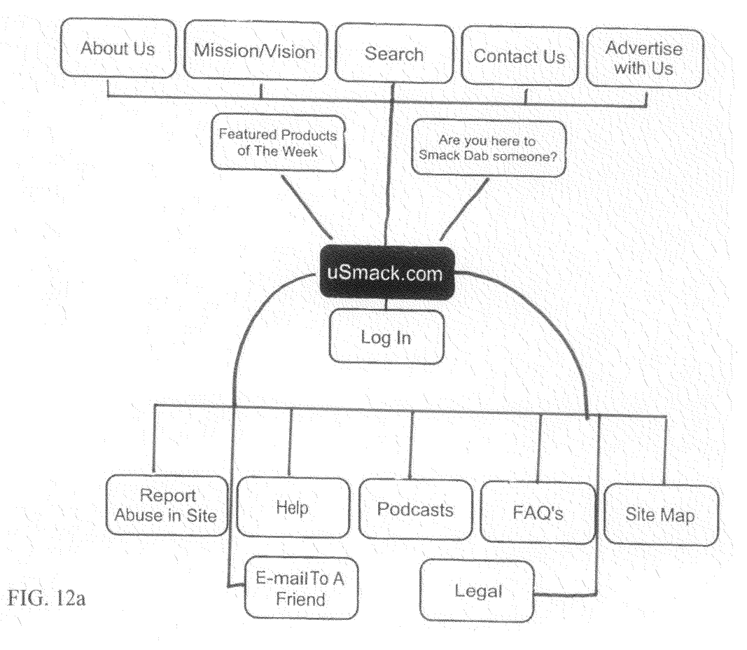

FIG. 12b depicts a block diagram of an exemplary embodiment of a merchandise page of the communication system and alternate pages that a user may select therefrom;

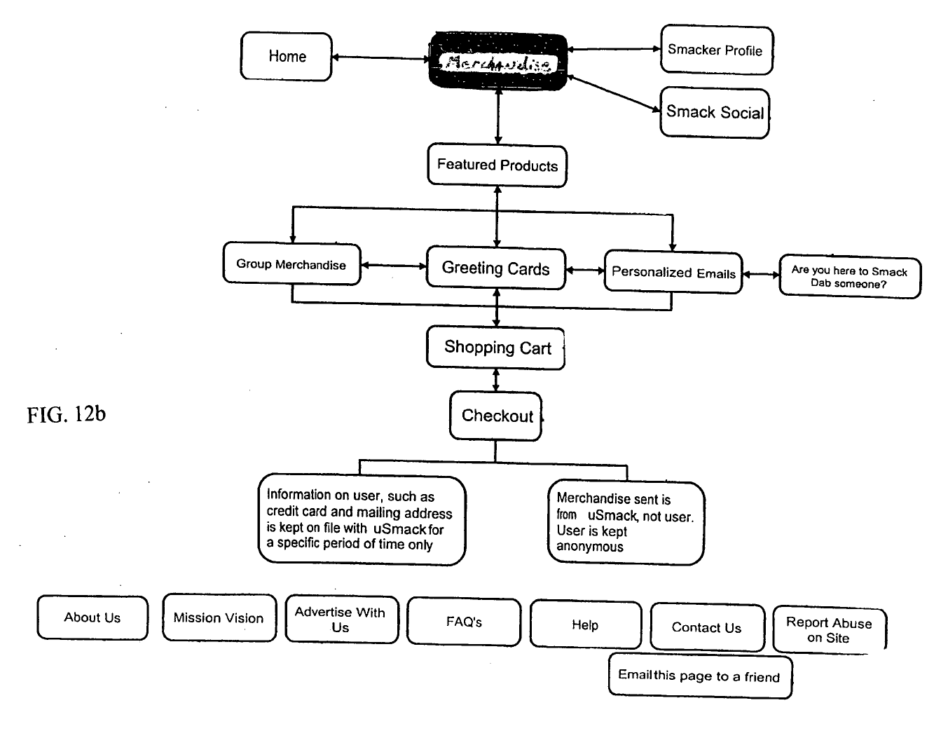

FIG. 12c depicts a block diagram of an exemplary embodiment of a social page of the communication system and alternate pages that a user may select therefrom;

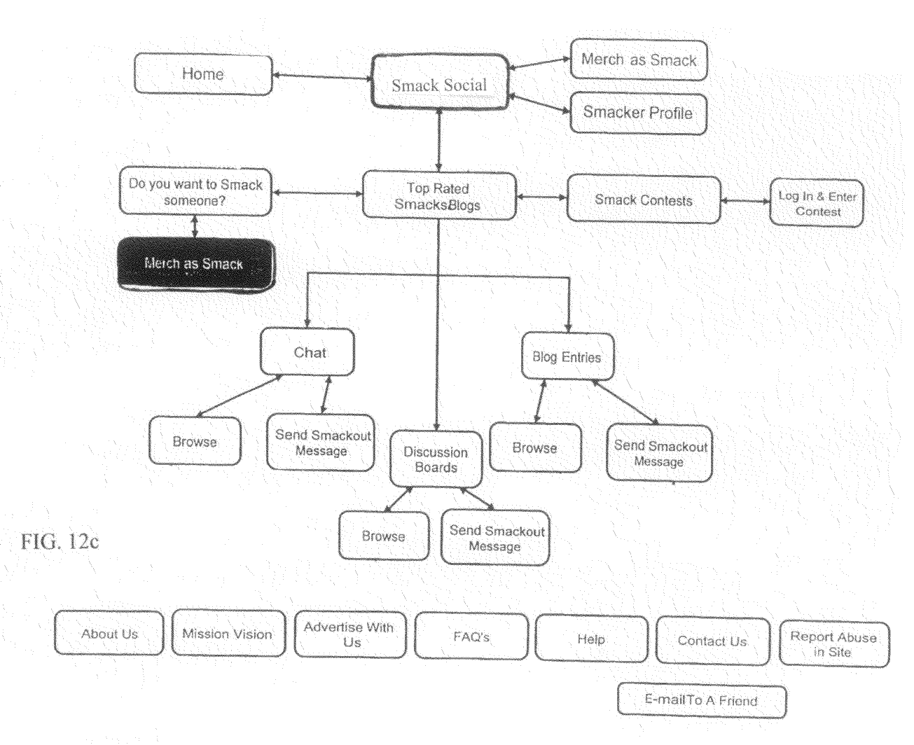

FIG. 12d depicts a block diagram of an exemplary embodiment of a legal page of the communication system and alternate pages that a user may select therefrom.

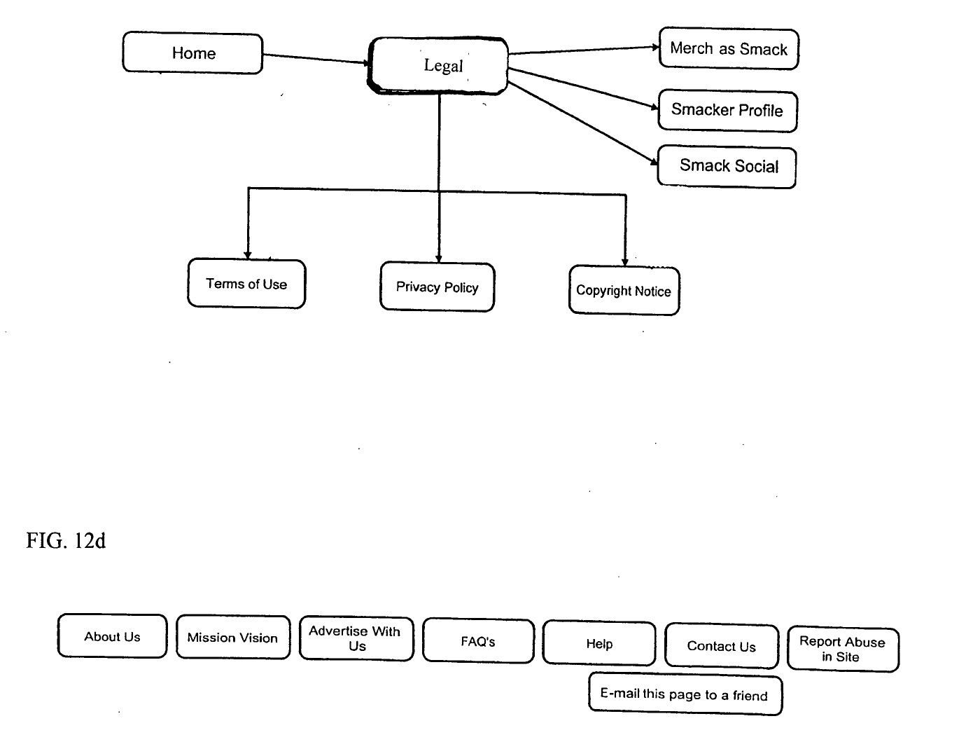

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

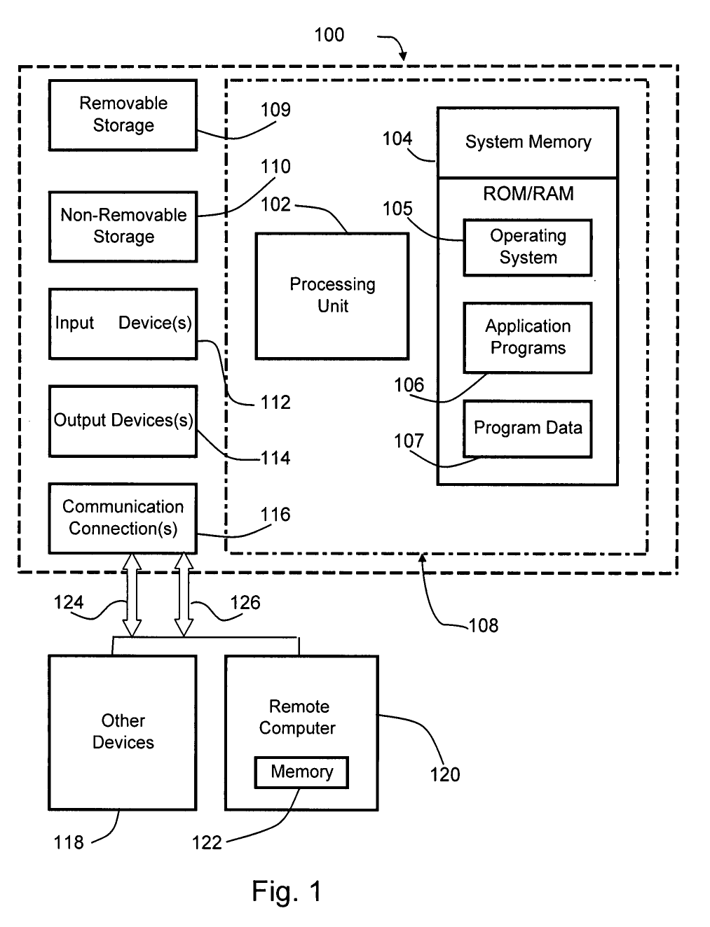

FIG. 1 illustrates an example of a suitable computing system environment in the form of a computing device 100 on which the present system may be implemented. The computing device 100 is only one example of a suitable computing environment and is not intended to suggest any limitation as to the scope of use or functionality of the present system. Neither should the computing device 100 be interpreted as having any dependency or requirement relating to any one or combination of components illustrated in the exemplary operating environment. The system is operational with numerous other general purpose or special purpose computing system environments or configurations. Examples of well known computing systems, environments, and/or configurations that may be utilized include, but are not limited to, personal computers, server computers, network PCs, minicomputers, mainframe computers, distributed computing environments that include any of the above systems or devices, and the like.

The system may be described in the general context of computer-executable instructions, such as program modules, being executed by a computer. Generally, program modules include routines, programs, objects, components, data structures, etc. that perform particular tasks or implement particular abstract data types. The system may also be practiced in distributed computing environments where tasks are performed by remote processing devices that are linked through a communications network. In a distributed computing environment, program modules may be located in both local and remote computer storage media including memory storage devices.

Referring to FIG. 1, an exemplary system includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more application programs 106, and may include program data 107. Examples of application programs 106 include phone dialer programs, e-mail programs, scheduling programs, PIM (personal information management) programs, word processing programs, spreadsheet programs, Internet browser programs, and so forth. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included. All these devices are known in the art and need not be discussed at length here.

Computing device 100 also contains communication connection(s) 116 that allow the device to communicate with other devices 118 (including printing devices, stand alone e-mail servers, facsimile devices, and the like), such as over a network or a wireless mesh network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

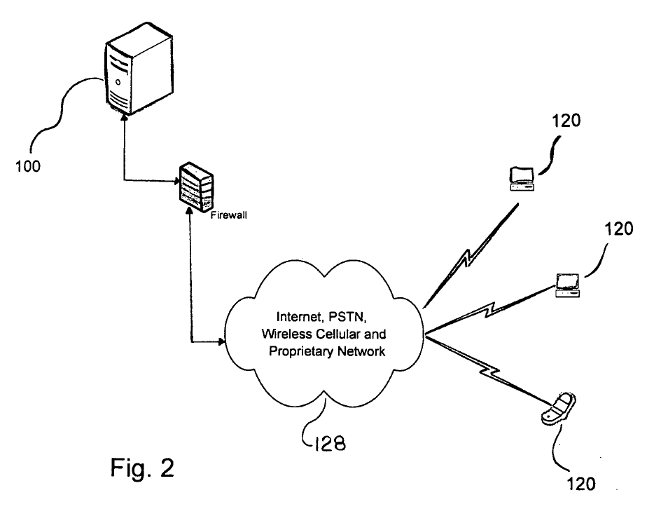

The computing device 100 may operate in a networked environment using logical connections to one or more remote computers, such as a remote computer 120. The remote computer 120 may be operated by a client, consumer or third-party service provider (including one or more providers of various information databases, research tools, reporting services, and the like); may take the form of a personal computer, a server, a router, a network PC, PDA, a peer device, or other common network node; and typically includes many or all of the elements described above relative to the computing device 100. It is further contemplated, however, that the remote computer 120 could be provided in the form of a telephone, which includes cellular telephones, landline telephones and the like. The logical connections depicted in FIG. 1 include a local area network (LAN) 124 and a wide area network (WAN) 126, but may also include other proprietary and non-proprietary networks 128, such as wireless networks, a PSTN, the Internet, an intranet, and the like. It will be appreciated, however, that the network connections shown are exemplary and other networking and communications means may be used. FIG. 2 illustrates an example of a suitable system environment on which the present invention may be implemented.

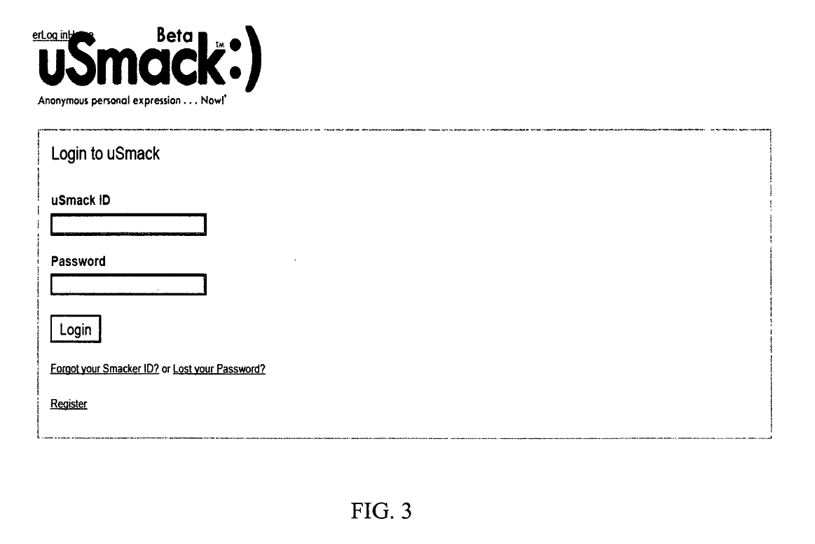

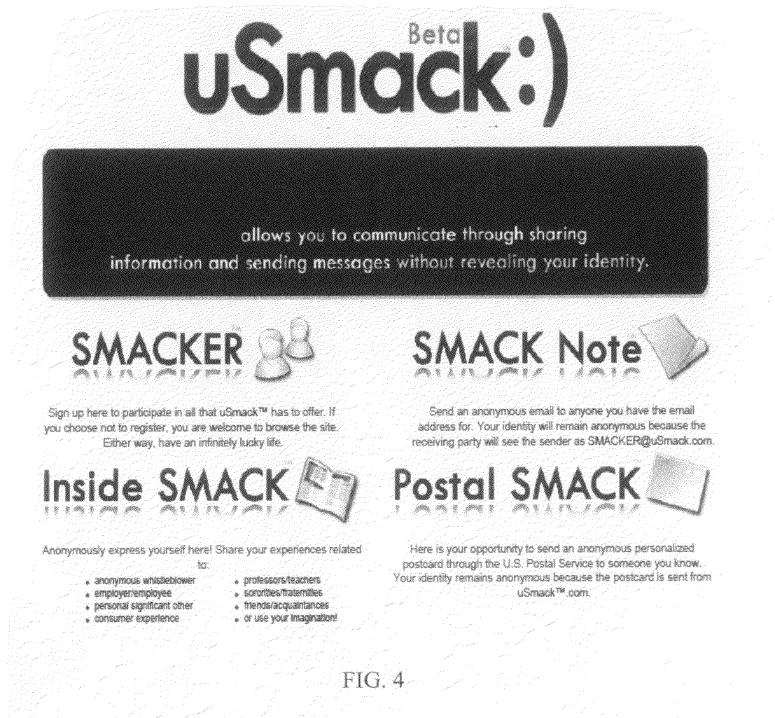

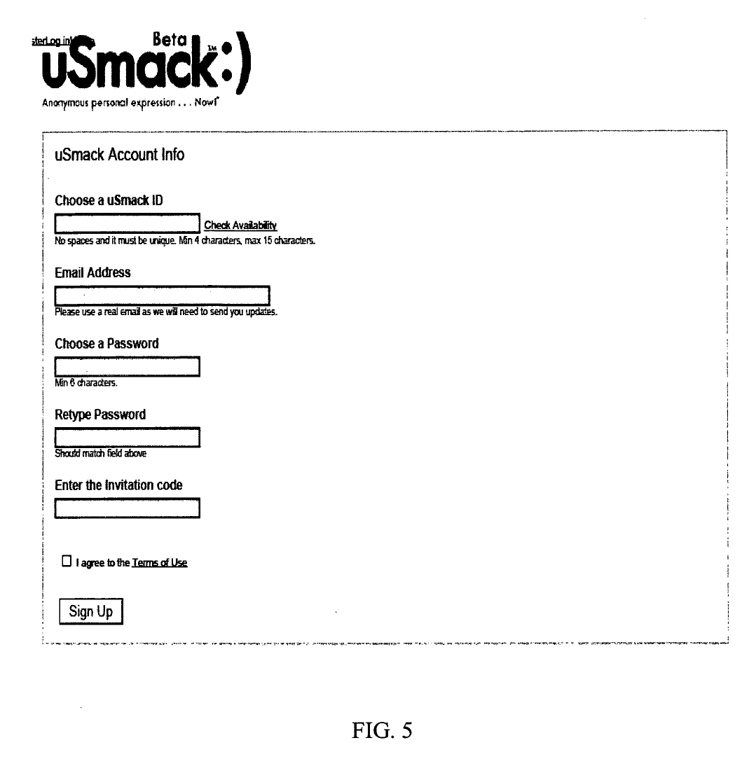

In one particular embodiment, the communication system 10 is accessed via the Internet and is hosted, alone or in part, by the computing device 100, serving as a communications hub. Users may access a home page, such as that depicted in FIG. 4, using a remote computer 120 or other similar device. Various embodiments of the home page may provide access to a user log-in facility (such as that depicted in FIG. 3), an account set-up page (such as that depicted in FIG. 5), as well as links to other pages for: reporting abuse on the site; user help; pod casts; FAQ's; a site map, and emailing the home page to one or more friends. More importantly, however, the home page provides the user with links to separate pages for: sending an anonymous email; participating in a community forum of anonymous users; and sending an anonymous postcard or other common postal medium.

With reference to FIG. 5 profile page the user is provided with the ability to establish a user account. A user account may be required to order goods and services elsewhere in the system or otherwise participate anonymously in the services provided by the system. Once the user has chosen an anonymous name, they can click an icon to verify the availability of a particular ID. Then a sign up page may be accessed by the user. Before confirming registration user may be asked to read and agree to the Terms of Use for the uSmack site. By registering, a user may be provided an account that permits the user to privately receive email replies, post email replies, and the like.

After the user has established an account, the user may use a dashboard, which will enable the user to more easily maneuver through uSmack website. The user may be presented with a variety of options, such as creating, viewing and/or editing their user profile. In one aspect, the user may be permitted to design the user's own, or use predetermined options to establish the user's public profile. The user may also provide confidential information regarding user preferences, activities, and the like. Such information may then be used by the system operator to customize system options or future communications to the user. The system may also permit the user to join or establish various community and group communication features supported by the system. Certain information provided by the user may not be published. Other aspects such as a blog may be published if so desired by the user. In a preferred embodiment, the user can edit/create a blog entry and/or view all entries.

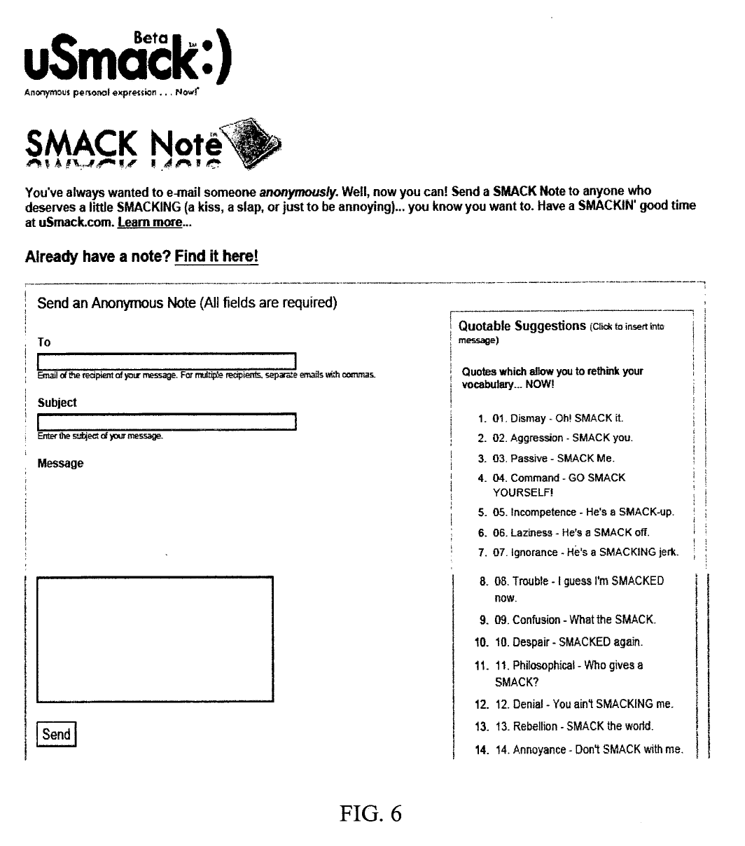

FIG. 6 depicts one contemplated embodiment of a screen, selectable from the home page, in which the user is able to create a directive for the system to deliver an anonymous communication. The user completes the blank portions of the screen, providing the recipient's email address, a personalized message, and the like. In a preferred embodiment, the user is then moved to a confirmation page to confirm the communication/message and other user-provided information. Once confirmed, the user may be directed to a transmittal page to send the communication. While the communication may be transmitted by email, SMS messaging, facsimile transmissions and other electronic methodologies are contemplated. Delivered communications will reveal an identify relating only to the communications hub (service provider) and not the user's identity.

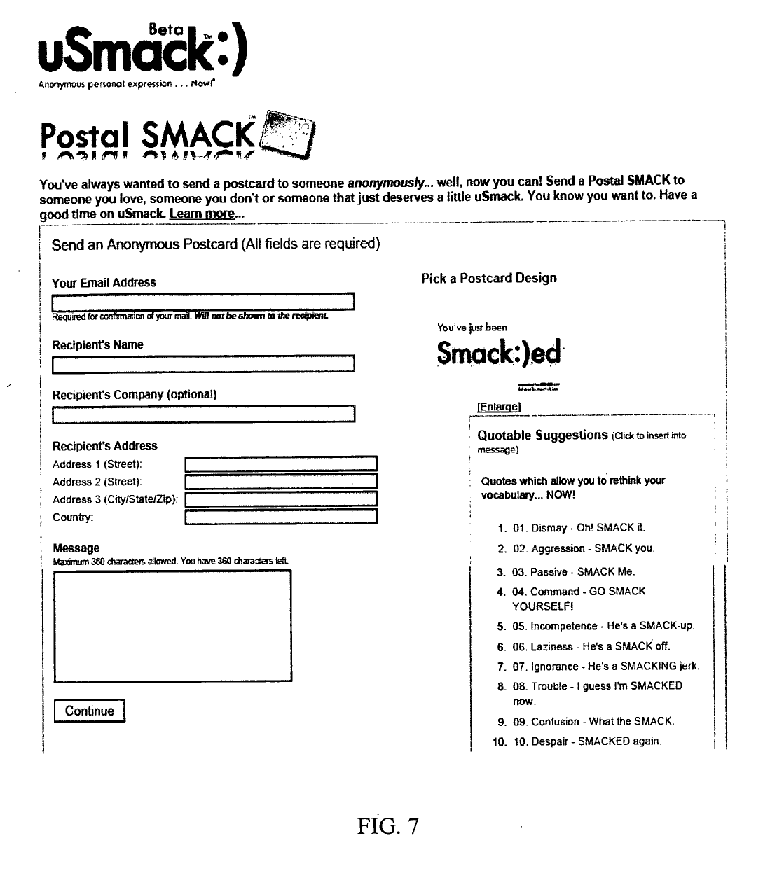

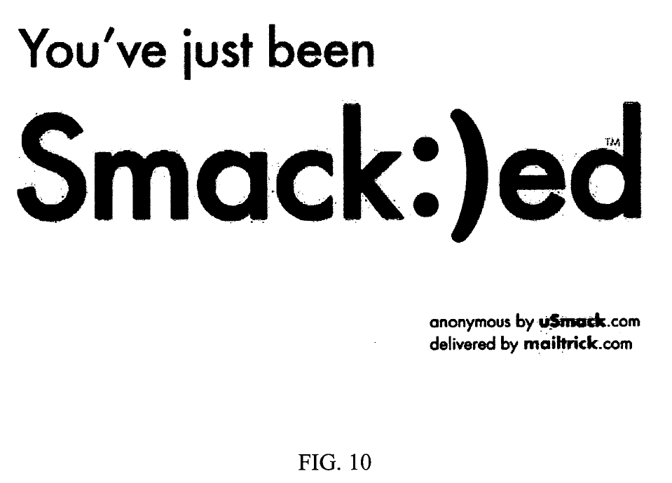

From the home page, selecting the link to send an anonymous post card, presents a page similar to that depicted in FIG. 7. Preferably, the user will be asked to enter the user's email address, the recipient's name, company name (if applicable), address, country, and a personalized message. Suggested messages or passages may be provided in a list or other grouping from which the user my select to include within the personalized message. Thereafter, by selecting the “continue” icon, the user may be directed to a page where the information and contents of the communication may be confirmed by the user. The user then selects a product/postcard to serve as the communication carrier. An example of a postcard that may be made available to the user is depicted in FIG. 10. A page depicting the user's shopping cart may then presented. From this page, the user may elect to proceed to continue shopping, or the user may click on a check out button to access a check out page and procure delivery of the acquired product and instructed through the checkout procedure.

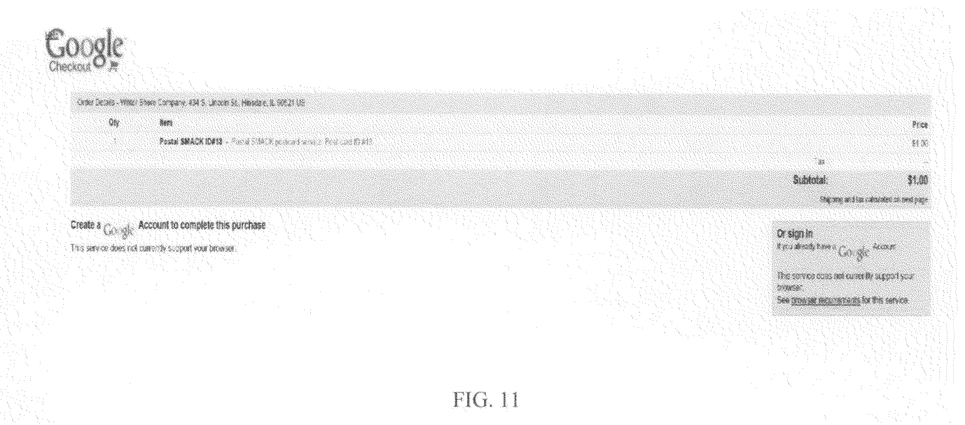

The user may also select a merchandise page, on which the user is presented with one or more featured products (and services) that may be purchased by or through the system. The user may shop through the page by clicking on one or more icons (in each case to access respective associated pages) for group merchandise, greeting cards, flowers/candy, personalized emails, personalized individual gifts and other products and services. Each such page provides the user with a variety of predetermined products, services. The types of products and services are nearly limitless, however, and the aforementioned examples are merely provided for illustrative purposes. Upon the user's selection of any such products, services, or communications in one or more of such pages, a page depicting the user's shopping cart may be presented. From this page, the user may elect to continue shopping or click on a check out icon to access a check out page, such as that depicted in FIG. 11.

The check out page provides data input pages for the user to enter payment information, with the credit information preserved for only a limited amount of time. The check out page also provides access to delivery information through which the user is provided with the option of having the site operator or entity procured by the operator deliver one or more of the selected products, services, or communications. All merchandise is preferably sent uSmack.com or other third party and not the user. All contact, financial and identity related information for each user is kept anonymous.

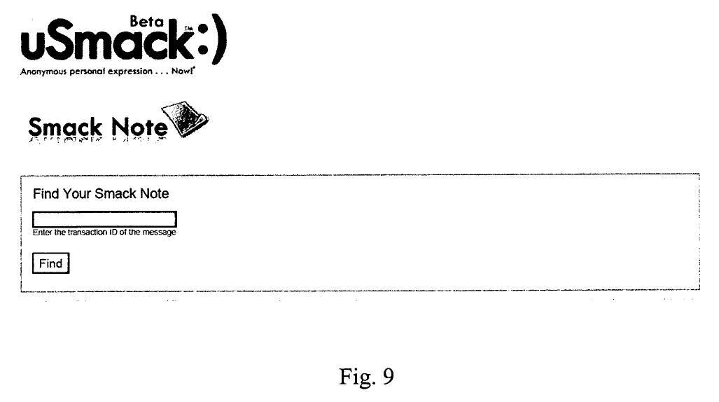

In a particular embodiment, the user may be able to access a community activity, social communication page or various pages dedicated to chats, discussion boards, or blogs. In each of these latter pages, the user may be provided with options to browse similar pages (chats, discussions boards, and blogs as applicable) and to develop a Smack™ product, service, or communication, as applicable, to be sent to a third party. FIG. 9 depicts an exemplary screen shot of a user interface for searching a database for previously prepared communications. Similar screens may be presented to a user for searching other databases of information within the system.

From the home page, a user may also be provided with the ability to anonymously browse the world wide web or gain access other pages that allow the user to browse the web site by subject, browse users, and search for those who have issued anonymous SMACK activity. All of these browsing activities by a user are confidential and not publicly available to other users. A wide variety of linking arrangements may be provided among various pages to provide increased flexibility in use of the system.

It is contemplated that one or more pages accessed throughout the system can include, if and as desired, other types of information and access to related pages. Example subjects may include “SMACKIN with the Founders” Blog, Tell us What you Think, Terms of Use, Contact Us, Privacy Policy, FAQ's, About us, Bookmark Us, or Blog (company blog for uSmack).

Although the above embodiments have been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

What is claimed is:

1. A method of facilitating anonymous communications between a first party and a second party, through the use of a facilitator, the method comprising:
providing a communication hub for receiving and distributing communications to parties over one or more communications media;
receiving a communication directive at said communications hub from the first party; said communication directive including instructions for the manner in which a communication is to be delivered to the second party; and
delivering said communication to the second party, via a first communications medium;
said communication including a presentation of a communicator identity to the second party; said communicator identity being relative to said communication hub but anonymous with respect to an identity of the first party.

2. The method of claim 1 wherein said first communications medium is comprised of postal delivery by a postal carrier and said communications directive includes an address for the second party.

3. The method of claim 2 wherein said communication directive includes a request for a written message to be provided on a post card to be delivered to the second party address.

4. The method of claim 2 wherein said communication directive includes a request for a product to be purchased and delivered to the second party address.

5. The method of claim 1 wherein said first communications medium is comprised of electronic data transmission means.

6. The method of claim 5 wherein said electronic data transmission means is comprised of an e-mail.

7. The method of claim 5 wherein said electronic data transmission means is comprised of an SMS transmission.

8. The method of claim 5 wherein said electronic data transmission means is comprised of an facsimile transmission.

9. The method of claim 5 wherein said electronic data transmission means is comprised of a blog supported on a network.

10. The method of claim 1 further comprising:
registering the first party with the facilitator prior to receiving a communication directive at said communications hub from the first party.

11. The method of claim 10 wherein said registration includes the creation of a fictitious identity for the first party and instructions concerning the delivery of communications to the first party.

12. The method of claim 11 wherein said communication further includes a presentation said fictitious identity to the second party.

13. The method of claim 12 further comprising:
providing the second party an opportunity to respond to the first party by receiving a second party communication directive at said communications hub from the second party and delivering a reply communication to the first party, according to said second party communication directive.

14. The method of claim 1 further comprising:
providing the first party with a plurality of suggested messages for inclusion in the communication prior to receiving said communication directive at said communications hub from the first party.

15. The method of claim 4 further comprising:
providing the first party with a plurality of products, available for the first party to purchase, by or through the facilitator, prior to receiving said communication directive at said communications hub from the first party.
